(19) United States
(12) Patent Application Publication
(10) Pub. No.: US 2006/0144648 A1
(43) Pub. Date: Jul. 6, 2006

(54) Vehicle braking system

(75) Inventor: Dror Ben Aharon, Kfar Hogla (IL)

Correspondence Address: BACHMAN & LAPOINTE, P.C., 900 CHAPEL STREET, SUITE 1201, NEW HAVEN, CT, 06510, US

(73) Assignee: MAG-EH LTD.

(21) Appl. No.: 11/323,579

(22) Filed: Dec. 29, 2005

(30) Foreign Application Priority Data
Jan. 3, 2005 (IL) 166,124

(51) Int. Cl. F16D 65/14

(52) U.S. Cl. 188/2 D

(57) ABSTRACT

There is provided a vehicle braking system for activating at least two wheel brake units, the vehicle including a brake activation assembly incorporating a movable force applicator, the system having at least one section of a cable conduit, one end of which being stationary, the other end of the conduit section being operationally coupled to the movable force applicator and a cable, at least partly strung inside the conduit section, the ends of which cable being respectively attachable to the brake units. Upon actuation of the brake activation assembly, the movable force applicator causes the conduit section to curve, thereby forcing the cable to activate the brake units attachable to each of its ends.

### FIELD OF THE INVENTION

The present invention relates to a system for simultaneous activation of a plurality of vehicle's wheel brakes.

### BACKGROUND OF THE INVENTION

Each wheel of wheeled vehicles is commonly equipped with a brake unit. Brake units are usually operated by a single actuator applying an equal force to each of the units. The known systems apply an equal tension to a plurality of cables, each of which individually pulls the brake mechanism associated with a single wheel. A typical prior art system, in its state of rest and activated state, schematically illustrated in FIGS. 1(a) and 1(b), comprises a first cable 2 passing through a bent conduit 4 having a fixed end 6 and a movable end 8. As seen in FIG. 1 (b) upon pulling the first cable 2 at its first end 10 by a force applicator 12 located in a brake activation assembly 14, the cable's second end 16 activates one brake 18 of wheel 20. Simultaneously, the tension built in cable 2 exerts force from within on the bent conduit 4, bending it further and consequently causing the movable end 8 to move and pull a second cable 24, while translating coupling unit 22. In turn, the cable 24 activates a second brake 26 of wheel 28. Conduits 30 and 32 serve as protection and guides for cables 2 and 24, respectively.

One difficulty encountered with this mechanism resides in the relatively complex and large volume it occupies at the cramped space available in many modern vehicles.

### DISCLOSURE OF THE INVENTION

It is therefore one of the objects of the present invention to provide a brakes activation system, which involves less elements and components, thus occupying less space.

According to the invention, this is achieved by providing a vehicle braking system for activating at least two wheel brake units, said vehicle including a brake activation assembly incorporating a movable force applicator, said system, comprising at least one section of a cable conduit, one end of which being stationary, the other end of said conduit section being operationally coupled to said movable force applicator; a cable at least partly strung inside said conduit section, the ends of which cable being respectively attachable to said brake units, wherein upon actuation of the brake activation assembly, the movable force applicator causes said conduit section to curve, thereby forcing the cable to activate the brake units attachable to each of its ends.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1 (a) and 1(b) schematically illustrate prior art structures of a brake activation system, in two operation states, and

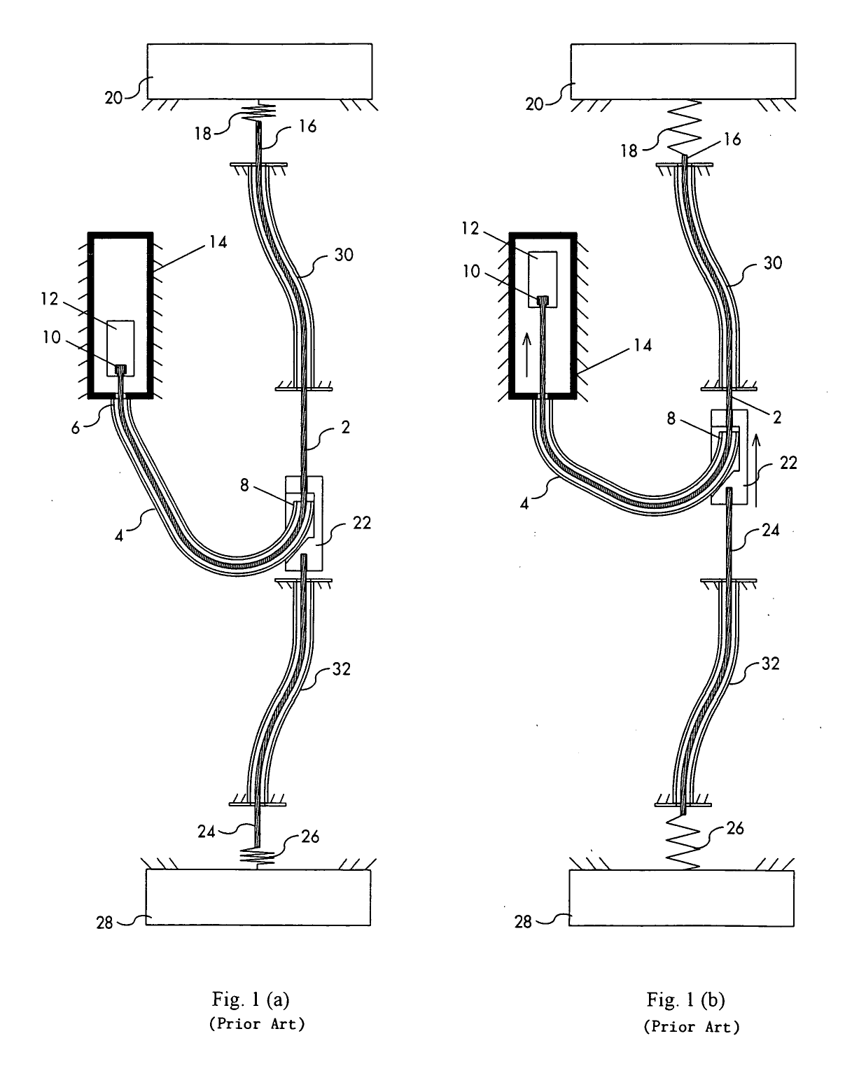

FIGS. 2 (a) and 2 (b) schematically illustrate structures of the brake activation system according to the present invention, in a state of rest, and respectively, in its activated state.

### DETAILED DESCRIPTION OF PREFERRED EMBODIMENTS

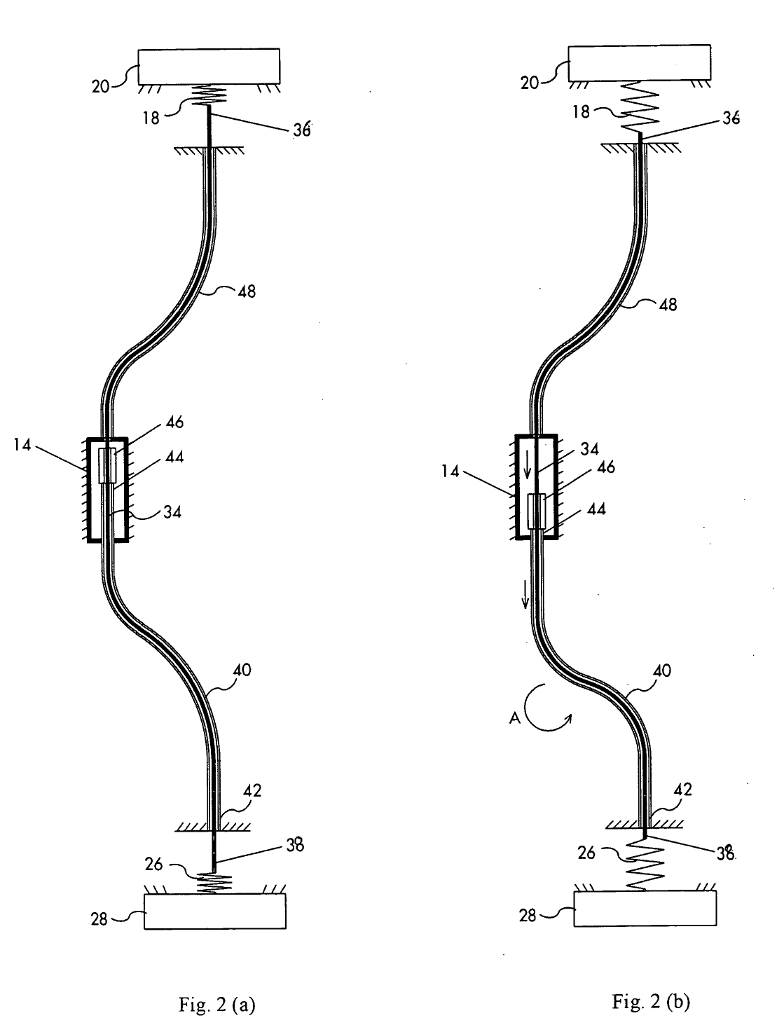

Referring now to the drawings, there are seen in FIGS. 2 (a) and 2 (b), a schematic structure of the brake activation system according to the present invention. FIG. 2 (a) illustrates the system in its released state. A cable 34 has a first end 36 operationally coupled to a first brake unit 18 of wheel 20 and a second end 38 operationally coupled to a second brake unit 26 of wheel 28. The cable 34 passes through an advantageously smooth, slightly pre-curved, conduit 40 having a first fixed end 42 and a second movable end 44 attached to a force applicator 46 being movable relative to the vehicle's framework. FIG. 2 (b) illustrates the system in its activated state. Upon operating the brake activation unit assembly 14, e.g., an electric parking brake device facilitating axial movement of the force applicator 46. The force applicator 46 pushes the movable end 44 of the conduit 40, causing the conduit to curve further as indicated in arrow A, thus creating tension in cable 34. Consequently, the cable ends 36 and 38 activate brake units 18 and 26 of wheels 20 and 28, respectively, by an equal force. Conduit 48 being fixed at both ends, serves only as protection and guide for a part of cable 34.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A vehicle braking system for activating at least two wheel brake units, said vehicle including a brake activation assembly incorporating a movable force applicator, said system, comprising:
at least one section of a cable conduit, one end of which being stationary, the other end of said conduit section being operationally coupled to said movable force applicator;
a cable, at least partly strung inside said conduit section, the ends of which cable being respectively attachable to said brake units,
wherein upon actuation of the brake activation assembly, the movable force applicator causes said conduit section to curve, thereby forcing the cable to activate the brake units attachable to each of its ends.

2. The system as claimed in claim 1, wherein said conduit section is slightly pre-curved, facilitating its further curving upon pushing said movable force applicator.

3. The system as claimed in claim 1, wherein said brake activation assembly is an electric parking brake device and said force applicator is axially movable therein.

4. The system as claimed in claim 1, further comprising at least one additional cable conduit section surrounding a section of said cable, one end of which conduit section is attached to said assembly and the other end is attachable to the vehicle.
